(19) United States
(12) Patent Application Publication
(10) Pub. No.: US 2004/0255879 A1
(43) Pub. Date: Dec. 23, 2004

(54) Harmonic sliding slotted link mechanism for piston engines

(76) Inventor: Igor Zaytsev, Kiev (UA)

Correspondence Address: Igor Zaytsev, 30/2, Ushinskoho st., ap. 37, Kiev, 03151, UA

(21) Appl. No.: 10/463,828

(22) Filed: Jun. 17, 2003

(51) Int. Cl. F02B 75/24; F02B 75/32

(52) U.S. Cl. 123/55.2; 123/197.4

(57) ABSTRACT

The invention disclosures a new type of connection of a crankshaft with pistons in piston engines. Pistons and crankshaft are connected using so called sinusoidal or harmonic mechanism. Such mechanism allows to reduce quantity, dimensions and mass of piston group details, to simplify their shape and manufacturing technology. The mechanism improves density of connection between cylinder and the piston, ensures smoother motion of the piston, improves conditions of combustion of fuel. New variants of an arrangement of cylinders and pistons allow to reduce dimension and mass of the cylinder block and whole engine. Reduction of kinematic links number lets to reduce vibration, mechanical noise, deterioration of pistons and walls of cylinders. The invention can be used in design and production of many types of piston engines.

### CROSS REFERENCE TO RELATED APPLICATIONS

Not applicable

### STATEMENT OF FEDERALLY SPONSORED RESEARCH/DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

Most of existing internal combustion engines use a connection of crankshaft with pistons by means of slider-crank mechanism (SCM). This mechanism consists of such well known elements as piston, piston pin, piston rod and crankshaft. The SCM transforms pistons reciprocation into crankshaft rotation or vice versa. Historically, the SCM is an oldest unit of piston engines, it is widely used in technique for more than 250 years, since steam machines and up to modern automobile engines. This invention suggests to replace the SCM by harmonic sliding slotted link mechanism (HSSLM).

The SCM has one fundamental imperfection: it cannot be made as dynamically balanced mechanism. Traditional piston engines have such problems, like vibration during work, significant lateral loading from the piston on the cylinder walls causing soon deterioration of piston rings, piston body and cylinder surface. These problems cause loss of compression in cylinders which shorten life cycle of the engine before repair. The piston operates in heavy duty mechanical and temperature conditions. On the one hand the piston should adjoin densely to cylinder walls in order to minimize gas outflow from the combustion chamber. On the other hand, the piston has just movable connection with a piston rod which makes complex combined motion with big acceleration values. These acceleration vectors are directed not only along an axis of the cylinder, but also perpendicular to it—in a plane of piston rod motion. The perpendicular component of dynamic and static efforts from a piston rod to the piston cause unwanted deterioration of side walls of cylinder and piston. This deterioration becomes the main reason limiting life cycle of the engine and resulting to its repair.

Motion of piston rods is a main source of lack of balance and vibration during engine work. It is possible to compensate this vibration using counterbalance masses on crankshaft. However it cannot a problem finally and inevitably increases mass and dimension of the crankshaft, the cylinders block and whole engine. Another method of SCM vibrations reduction uses opposite arrangement of pistons in the engine (so called “boxer” engines). The opposite type engine demonstrates better dynamic characteristics and lower level of vibration, but it is more expensive in production because of more complex structure (two blocks of cylinders) and wider horizontal dimension. For these reasons the opposite engines are not very popular. At the moment of disclosing of this invention the opposite engines are used only by two serial car manufacturers—Porsche, Germany and Subaru, Japan.

The SCM has another vulnerable feature—its lubrication system. Lubrication of SCM details is made via single channel, drilled in the crankshaft. In case of a contamination of this lubrication channel there is a risk of engine overheating and “jammings” because of temperature deformation and damage of bushings and crankshaft journals. The mentioned problems result to great expenditures of design, production and operation of piston engines and machines which use them, first of all—automobiles.

This invention disclosures a new mechanism of connection of a crankshaft with pistons which is named by author as harmonic sliding slotted link mechanism (HSSLM) or simply harmonic mechanism. This mechanism allows to simplify kinematic links between the piston and crankshaft, to reduce number of details of the mechanism, to reduce the longitudinal dimension of cylinders, pistons and a crankshaft, and also the dimensions and mass of the whole engine, especially in case of opposite coaxial arrangement of cylinders. Harmonic mechanism has no piston rods, and therefore it has no problem of heavy vibration caused by them. So there is no necessity to use big counterbalances for a crankshaft that allows to provide additional mass reduction and simplification of crankshaft form. The offered harmonic mechanism allows to use the additional channel of lubrication, to improve operating conditions of rubbing parts. This lets to lower risks of engine's overheating and failure.

The invention is applicable for various types of piston engines: carburettor, diesel and injector, having both liquid, and air system of cooling. The invention can be applied in any area where piston engines are used: for cars and trucks of all types, motorcycles, tractors, road construction, industrial, agricultural and building machines, power-plants of sea and river vessels, light aircrafts, pumps, diesel engines—generators, derricks and other machines.

### BRIEF SUMMARY OF THE INVENTION

One of invention object (Claim 1) is a connecting mechanism between pistons and a crankshaft in piston engines. The invention represents harmonic sliding slotted link mechanism (HSSLM) which is proposed to use in piston engines instead of traditional slider-crank of mechanism (SCM). The invention's general idea is illustrated by FIG. 8 which compares traditional (bottom) and offered (top) engine structures. In the top figure there is shown a variant of harmonic engine with opposite coaxial arrangement of pistons, and in bottom—a traditional opposite engine with a horizontal arrangement of cylinders.

In the traditional engine with SCM (FIG. 8, bottom) a crankshaft journal 12 interacts with piston 9 via piston rod 27 and piston pin 25. In this mechanism the piston rod 27 has two degrees of freedom and makes complex cyclic motion in a plane of the figure, perpendicularly to the crankshaft axis. The engine with harmonic mechanism (FIG. 8, top) has no piston rods. In this engine one crankshaft journal interacts with two opposite coaxial pistons via slider 3. Here the function of piston rods is fulfilled by a slotted link 4 and slider 3. The slotted link 4 is motionlessly fixed with two pistons 9 or even makes an entire part with them. The slotted link 4 has only one degree of freedom and reciprocates together with pistons in horizontal direction. The slotted link 4 has vertical slot where slider 3 moves. Slider 3 acts as a link between round crankshaft journal and flat walls of slotted link. A number of kinematic pairs and details of harmonic engine is significantly less comparing to traditional engine with SCM. All HSSLM elements make simple motion (reciprocation or rotation), that reduces vibration of the engine. The engine is named by author as harmonic, because so-called sinusoidal or harmonic mechanism is used here. This mechanism has smoother dynamics of motion than traditional slider-crank mechanism with piston rods.

### THE BRIEF DESCRIPTION OF FIGURES

FIG. 1 is a general scheme of harmonic mechanism.

FIG. 2 is an exploded view of components of harmonic mechanism.

FIG. 3. shows kinematic formulas for harmonic mechanism and traditional slider-crank mechanism.

FIG. 4 is a simplified front sectional view of main structure of new engine: two opposite pistons connected by cross-rod which can move together along axis of cylinders and horizontal guide.

FIG. 5 is a horizontal section of piston group of four-cylinders opposite engine with harmonic mechanism

FIG. 6 shows a version of real structure of two halves of slotted link assembled on a crankshaft.

FIG. 7 illustrates a harmonic mechanism with disaxial allocation of pistons..

FIG. 8 shows advantage in transversal dimensions of harmonic piston group (top) comparing to regular opposite piston group (bottom).

FIG. 9 illustrates a difference in shape and longitudinal dimension (L) of crank-shafts for different types of 4-cylinder engines: traditional in-line engine (top); traditional V-like or opposite engine (middle); harmonic engine (bottom)

FIG. 10 is a table describing sequence of operation strokes and transmission of forces between pistons in four-cylinder harmonic engine with coaxial cylinders.

FIG. 11 illustrates advantage of external dimensions for harmonic engine comparing to traditional opposite engine.

FIG. 12 is a lubrication scheme of harmonic pistons and cross-rod.

FIG. 13 is a sectional view of harmonic mechanism used for engine with vertical in-line allocation of cylinders.

FIG. 14 is a variant of structure of the harmonic piston engine with a quadratic arrangement of cylinders in which each slotted link is fixed to four pistons.

### DETAILED DESCRIPTION OF THE INVENTION

The purpose of the invention was to create new connection of a crankshaft with the piston which lowers inefficient lateral loading of the piston on cylinder walls, improves impermeability of the cylinder-piston connection and reduces its deterioration.

1. Harmonic Sliding Slotted Link Mechanism

The basis of the invention is a usage of harmonic sliding slotted link mechanism in piston engine for transformation of pistons reciprocation into rotation of crankshaft or vice versa.

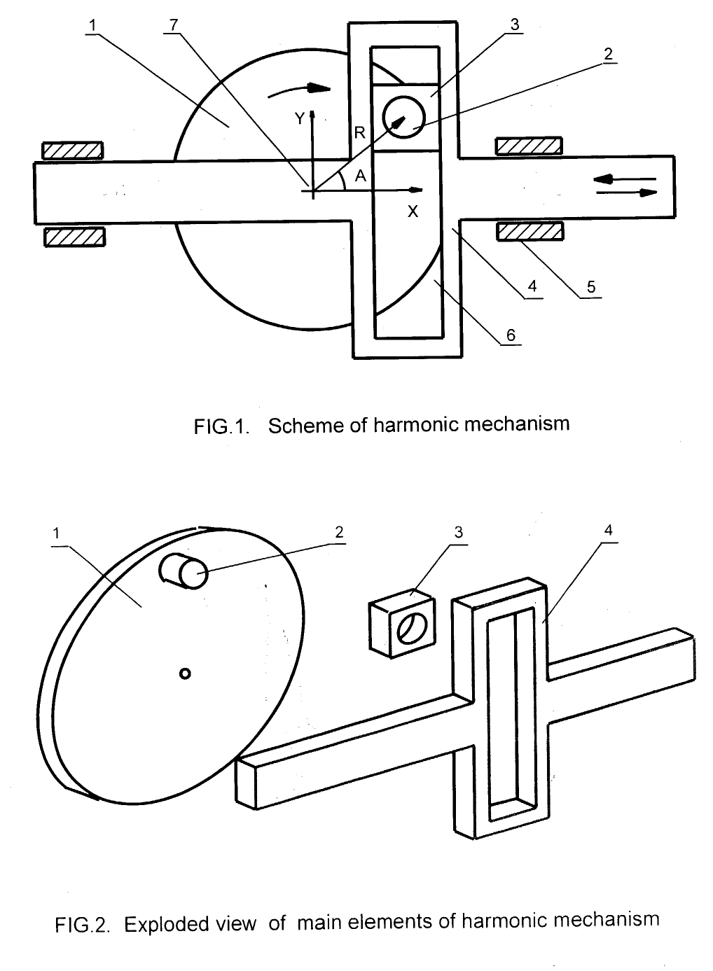

The FIG. 1 shows a scheme of the harmonic mechanism. The crank 1 is shown as a disk with attached journal 2. The crank 1 together with journal 2 rotates around of the disk center in a plane of the figure. The detail 4 which has a cross form, is a slotted link. It reciprocates back and forth along an axis X and along fixed horizontal guide 5. The slotted link has a vertical slot 6 in which slider 3 moves. The external surface of slider has rectangular form. In the center of slider there is a cylindrical aperture for crank journal 2. Slider reciprocates relative to the slotted link in a vertical direction along its slot 6. Lateral walls of slider slide along the slot 6 of slotted link which serve as a guide for the slider. If to consider slider motion relative to fixed details of the engine, it is a plane-parallel motion on a circle circumscribed by crankshaft journal. The slider is an interface element transmitting efforts from a flat surface of a slotted link to cylindrical crank journal. Basic elements of the mechanism are shown separately on FIG. 2.

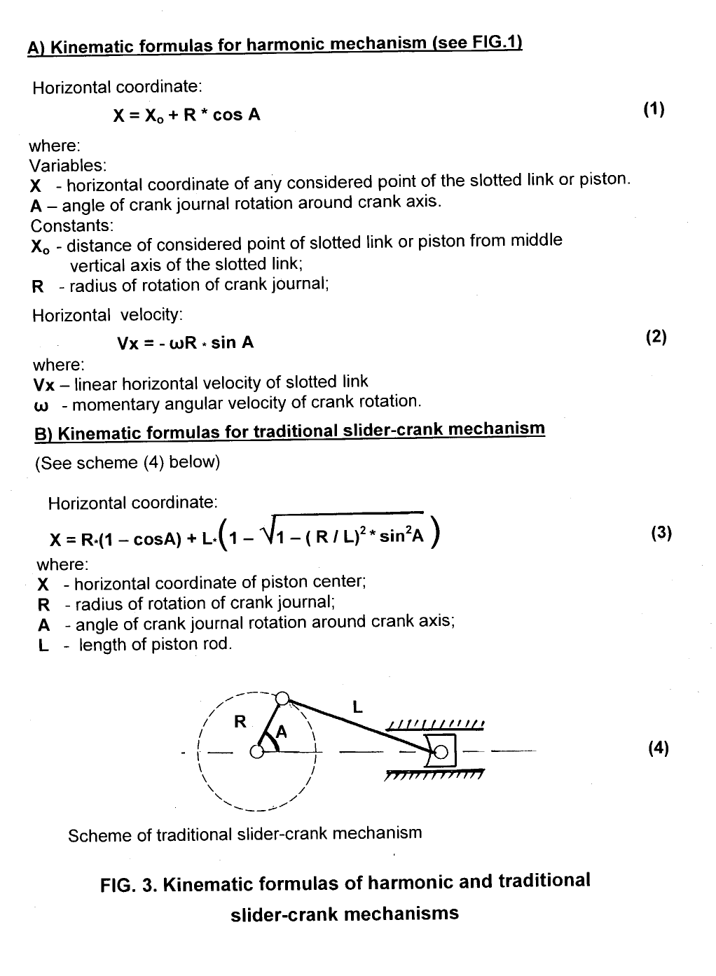

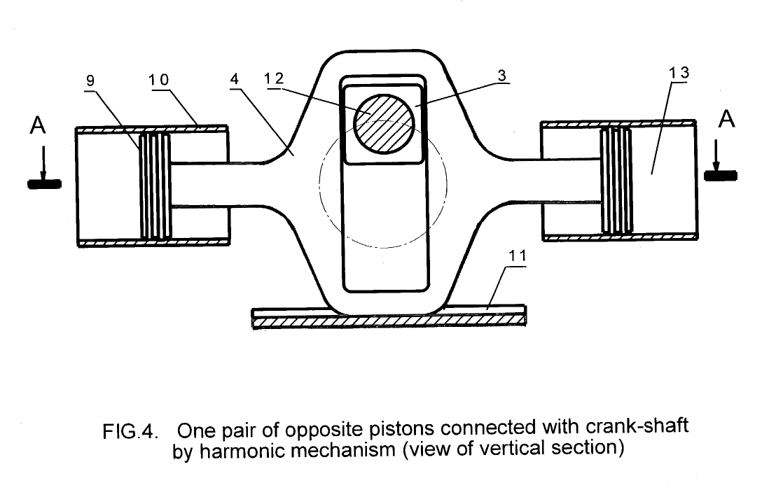

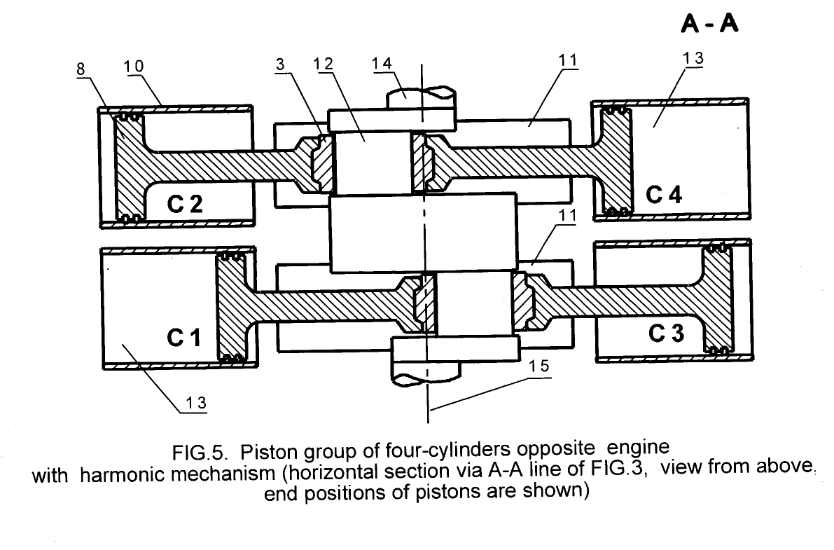

In the offered mechanism there is sinusoidal dependence between displacement of a slotted link and crank rotation angle. If to consider coordinate system on FIG. 1 and uniform rotation of the crank, then the motion of any point of a slotted link is determined by the formula (1) represented on FIG. 3. Horizontal speed of a slotted link also is a sinusoidal function of angle A. This function is described by the formula (2) represented on FIG. 3 which can be received by differentiation of the formula (1) on time.

Taking into account sinusoidal dependence between displacement of a slotted link and a crank rotation angle, the mechanism is named by author as harmonic sliding slotted link mechanism. The mechanism can be used both for transformation of rotation into reciprocation, and conversely—from reciprocation into rotation. In the text of this specification the engine with harmonic mechanism hereinafter is for short referred as harmonic engine, while existing engines with slider-crank mechanisms are referred as traditional engines.

In order to compare kinematic differences of the harmonic engine from traditional engines with let us consider the formula (3) FIG. 3 of dependence between a crank rotation angle A and displacement of axial slider-crank mechanism which is usually used in most of traditional engines of internal combustion.

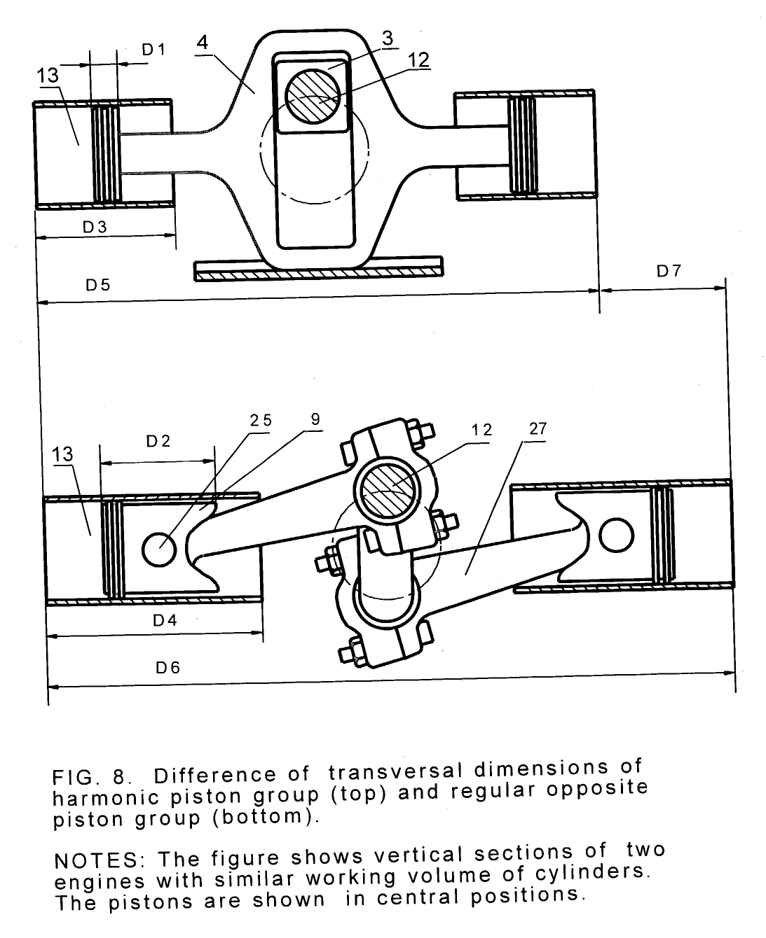

The formula (3) is much more complex than the formula (1) above it. Formulas for speed and acceleration of SCM piston which can be received by differentiation of the formula (3) on time, look much more complex. Because of that they are not presented in this specification. Complexity of the formula (3) reflects complex nonlinear character of kinematic links between the piston and a crank in traditional slider-crank mechanism. One more lack of the traditional mechanism is asymmetric character of piston acceleration. This acceleration in the top dead point (see extreme left position of the left piston on FIG. 8, below) usually is about twice more, than piston acceleration in the bottom dead point (see extreme right position of the same piston on FIG. 8). During engine high speed operation this peak acceleration and piston rods inertia create vibration jerks and critical conditions of durability for connection of the piston with a piston rod and crankshaft. In the harmonic engine (FIG. 8, top) for the same values of rotation speed, diameter of the cylinder and a piston stroke, the piston peak acceleration in the top dead point is approximately for 40-50% lower, than in traditional engine. In the harmonic engine accelerations of the piston in top and bottom dead points have symmetric character and they are identical. Smoother dynamics of the harmonic engine, and a fixed connection of the piston and a slotted link, allow to reduce considerably mass of pistons and a crankshaft.

Simplicity of kinematics and absence of a piston rod are main advantages of the harmonic mechanism in comparison with traditional slider-crank mechanism. Traditional piston rod makes complex motion which becomes a main source of unbalance for traditional mechanism. In the harmonic engine there is used a simple mechanical transfer of slotted link reciprocation to both sides from slotted link. In traditional engine it is possible to connect a piston rod with only one piston arranged on the one side of a crank, but in the harmonic engine such connection is possible for both sides of a slotted link. This advantage is used for invention of the mentioned harmonic engine with opposite coaxial arrangement of cylinders (FIG. 4 and FIG. 5).

Another advantage of the harmonic mechanism is that slotted link transfers to the crank (or on the contrary—perceives from a crank) longitudinal effort only (axis X on FIG. 1). Contrary to traditional engine, in harmonic engine the vertical forces between slotted link and crank are negligible. There are only vertical forces of friction in slotted link, but there are no significant vertical forces of piston rod inertia which exist in traditional engines. Harmonic mechanism has some static lateral loads of piston to cylinder, which have maximal value at angles of a crank 90° (as it is shown on FIG. 4) and 270°. However, these static loads are several times less than similar loads in traditional engines, because in harmonic engine one slotted link is connected with two pistons and horizontal guide 14 which perceive these forces together.

These advantages are used in the variant of opposite coaxial harmonic engine described below.

2. Opposite Coaxial Harmonic Engine

2.1. Arrangement of Cylinders

As an example, the four-stroke four-cylinder engine with horizontal opposite coaxial arrangement of cylinders is described (FIG. 4 and FIG. 5). The engine has a new arrangement of pistons and cylinders (Claim 2), new form of a crankshaft, pistons and case details of the engine. The cylinders 10 (left and right) are set in pairs horizontally, coaxial and opposite to each other. Cylinders 10 are fixed in the cylinder block in same manner as it is usually made in traditional opposite engines with a horizontal arrangement of cylinders. However, contrary to traditional opposite engines, the opposite cylinders of harmonic engine are set on common geometrical axis, that is coaxial, without any displacement along a crankshaft axis. Combustion chambers of cylinders 13 are situated at outward side of each cylinder, as well as in traditional opposite engine. For simplicity purpose the figures do not show such elements, like head of cylinders block and valve mechanism, because these elements do not require special differences from similar units of existing engines (excluding less dimension). Each pair of cylinders 10 (left and right) corresponds to one slotted link 4 which is rigidly connected with two pistons 9. A slotted link 4 together with pistons 9 as an entire detail, can slide horizontally along the axis of opposite cylinders while journal 12 of a crankshaft rotates about crankshaft axis. The slotted link is fixed from rotation around of cylinder axis by horizontal guide 11 which is fixed to the cylinder block or engine crankcase (the guide fastening is not shown on figures for simplicity). The guide 11 perceives a significant part of gravitational weight of a slotted link with pistons that allows to reduce weight loading on the lower part of cylinder walls and to reduce their deterioration. Usage of such guide which unloads cylinders walls is additional advantage of harmonic engine. For minimization of static loadings on walls of cylinders it might be used an additional top guide above the slotted link (the second top guide is shown on FIG. 7).

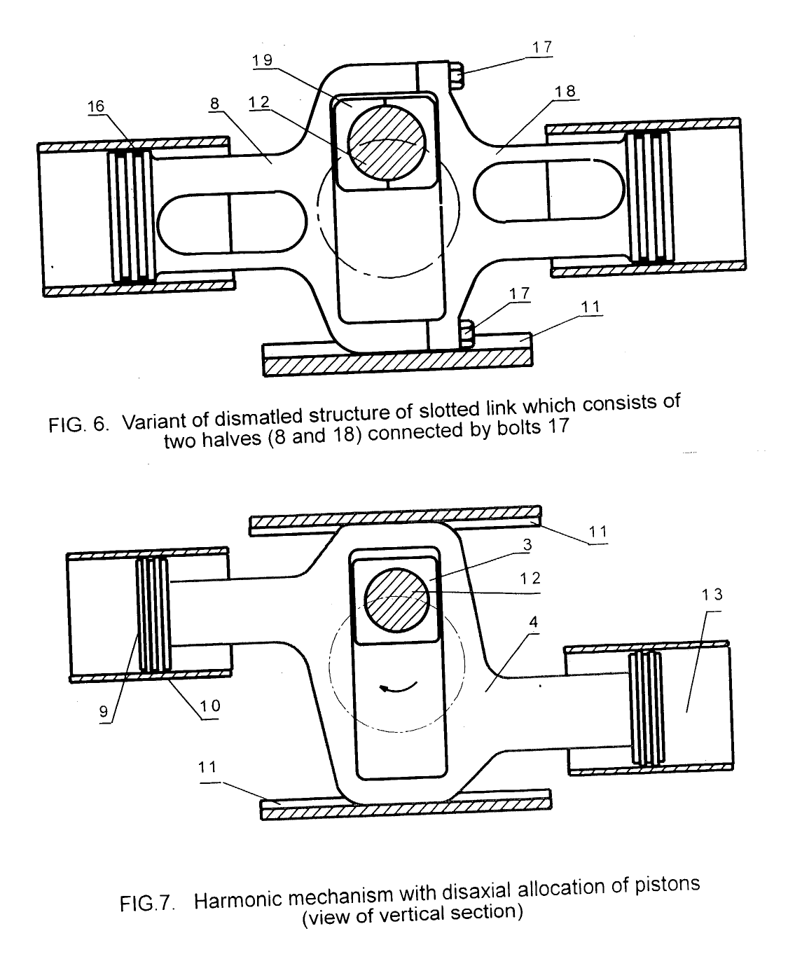

On FIG. 5 the horizontal section of the harmonic engine is shown (view along arrows of A-A section shown on FIG. 4). As it is seen from FIG. 4 and FIG. 5, an arrangement of opposite cylinders is strictly coaxial, i.e. the general geometrical axis of opposite cylinders crosses an axis of crankshaft rotation. However according to optimum designing of real engine there might be chosen so called disaxial opposite arrangement of pistons (see FIG. 6). At such arrangement the left cylinder axis is above a crankshaft axis, and the right cylinder axis is lower it. Such disaxial arrangement of cylinders allows to reduce the maximum bend of slot edges under piston loading and to reduce accordingly an entire slotted link mass. Disaxial arrangement of cylinders with the purpose of reduction of loading by lateral walls of the cylinder is frequently used in existing designs of engines with a various arrangement of cylinders (in-line, V-like or opposite). However for traditional engines disaxial arrangement of cylinders requires to increase piston rod length and weight, and therefore it is seriously limited. In harmonic engine there is no need to increase length or weight of a slotted link (compare FIG. 4 and FIG. 6 variants).

On a horizontal section of the mechanism on FIG. 5 there is shown a slider 3 form with a guide ledge which slides along a groove of a slotted link 8. Slider 3 envelops a journal 12 of crankshaft 14 which rotates around its geometrical axis 15. A slotted link 8 with pistons is shown on FIG. 5 as an integral detail. The position of a crankshaft 14 shown in FIG. 5 corresponds to end positions of pistons. During engine operation the slotted links 4 reciprocate along guide 11.

2.2. Design of Slotted Link and Pistons

For simplicity the slotted link 4 on FIG. 4 is shown as an integral detail. Such slotted link can be used for two-cylinder harmonic engine (i.e. for motorcycle). In such engine the crankshaft may have a journal on the end of a shaft, and in this case an integral slotted link and slider simply are put on the end of a shaft during assembling. For engines with number of cylinders more than two, the slotted link should be sectional (FIG. 6), consisting of two halves 8 and 18, each of which is fixed or integral with one piston. Variants of sectional structure of a slotted link is shown on FIG. 7. Each of slotted link halves may be an integral detail together with piston that improves heat removal from the piston head. The halves of slotted link are fastened among themselves by bolts 17 during assembling of the engine. Such design does not restrict assembling operations during engine production. At the assembling process the halves of slotted link have to be inserted in cylinders blocks first, then blocks of cylinders (left and right) are fixed together. Then slider halves are put on a crankshaft journals, and slotted link halves are moved closer to the crankshaft. Access of the assembly tool to bolts of a slotted link could be done easily both from the top cover or crankcase. Number of bolts to be screwed during assembling of harmonic engine piston group is twice less than corresponding number of bolts of traditional engine with same number of cylinders.

In traditional engines there exists a problem of combustion gas heat removal. The greatest problems are caused with heat removal from the head of the piston. The heat from piston is partly removed by thermal conductivity process through the piston lateral walls adjoining with cylinder and through connection of the piston with a piston rod. These connections of piston are movable, so they have some gap and cannot remove a heat effectively. This causes risks of overheating and thermal deformation or even burning-out of the piston head. The integral variant of a design of the piston and a slotted link in harmonic engine allows to solve better this problem, because there appears a heat transfer via continuous solid metal of a slotted link. Monolithic connection of opposite pistons with a slotted link also completely liquidates such well known problems of traditional engines, as skews of the piston in cylinder (engine jamming), elliptic deterioration of sleeves of cylinders, knocking noise in connection of the piston with a piston rod.

Harmonic engine pistons have also dimensional advantage shown on FIG. 8. Pistons of traditional engines (FIG. 8, bottom) have enhanced length D2 as their design demands a place for installation of a pin 25. Traditional piston needs also an additional space—a piston skirt 26 which is necessary for elimination of possible piston skews in the cylinder. Because the harmonic engine piston needs neither a “skirt” for skews prevention nor space for a piston pin, its length D1 (see FIG. 8, top) might be done in 2.5 . . . 3 times less, than length of piston D2 in the traditional engine (see. FIG. 8, bottom). The length D1 of harmonic piston is defined only by piston rings dimensions and minimum length of the piston required for keeping of gas pressure in the combustion chamber. Shorter piston length allows to reduce accordingly the length of cylinders. As it is seen from FIG. 8, the dimension D3 is much less, than dimension D4 of the traditional engine cylinder which corresponds to the same values of cylinder diameter, piston stroke and engine working volume. The difference between D4 and D3 is equal to the difference between D2 and D1. It allows to reduce horizontal cross-section dimensions of the engine by size D7, to reduce significantly a weight of cylinders blocks and whole engine.

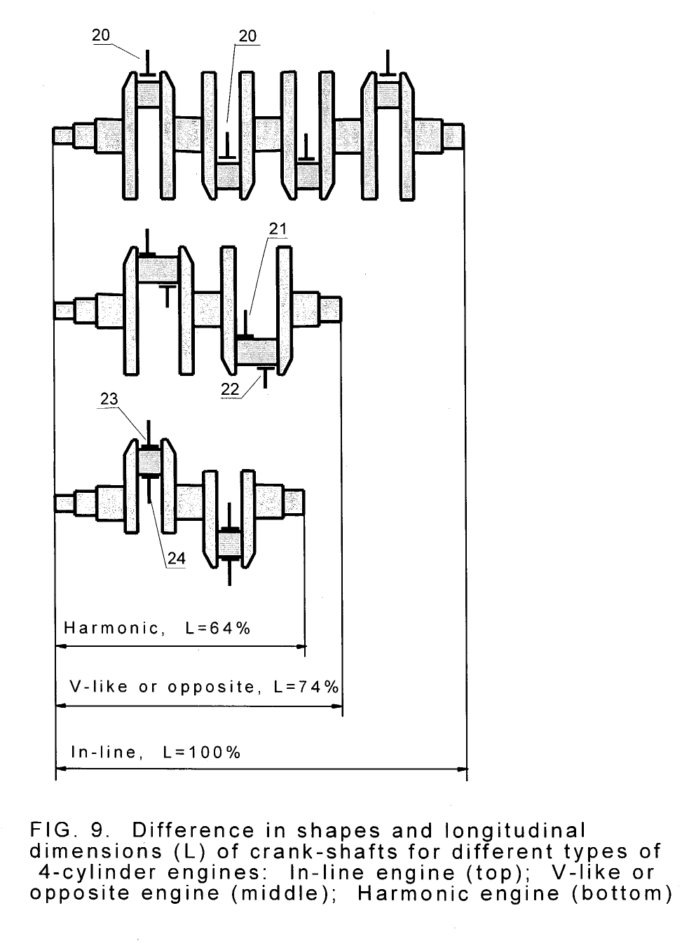

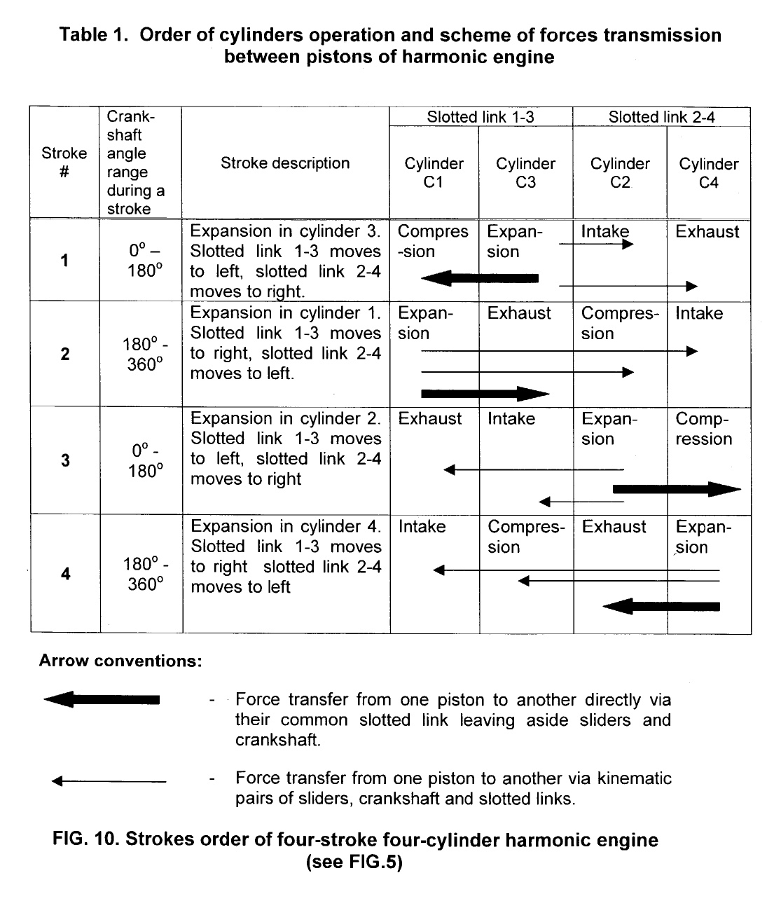

Advantages in the longitudinal dimensions of the engine are illustrated on FIG. 9 which shows forms of crankshafts for different types of four-cylinder engines. In this figure the T-symbols 20, 21, 22, 23 and 24 show positions of piston rods (for traditional engines) or slotted link (for harmonic engine) near crankshaft journals. It is important to note, that positions of piston rods 21 and 22 for traditional opposite or V-like engine are shifted relative to each other along an axis. But positions of pistons 23 and 24 for harmonic engine are not shifted. Reduction of piston group by size D7 allows to reduce accordingly width of the engine by the same size D8 (a difference between width D10 of traditional opposite engine and width D9 of the harmonic coaxial engine).

Due to significant vertical slot size of slotted link (its size corresponds to the piston stroke of the engine plus slider size) the slotted link on FIG. 4 and FIG. 6 looks bulky. This detail really has significant dimensions and mass. However, one slotted link with pistons in opposite harmonic engine corresponds to many details of traditional engine: two big pistons, two piston rods with pins, bushings, bolts. Therefore the general mass of a slotted link with slider and pistons for the harmonic engine due to first theoretical calculations appears lighter than corresponding group of details of traditional engine of same working volume (see distinction between FIG. 8 top and bottom). The number of details corresponding to one pair of cylinders of the traditional piston mechanism makes from 24 up to 30 units. In the harmonic engine this number is 6 units only, that is four times less. Absence of movable connections between a slotted link and pistons, and also simple reciprocation motion of a slotted link opens to designers wide opportunities for creation of new designs of piston rings and the optimum form of a slotted link. As an example on FIG. 6 the variant of a folding slotted link is shown in which each of halves 8 and 18 has windows for less mass.

2.3. Working Cycle of the Harmonic Engine

As an example of a running cycle of the harmonic engine the FIG. 10 describes a working cycle of cylinders of four-stroke four-cylinder opposite coaxial harmonic engine represented on FIG. 5. The table represents four strokes of the processes in cylinders C1, C2, C3 and C4. The beginning of a cycle and a crankshaft angle 0° relative to its geometrical axis 15 correspond to the pistons position shown on FIG. 5. Arrows on FIG. 10 show a direction of mechanical efforts from one piston to another. As the table shows the coaxial harmonic mechanism allows to transfer significant efforts from pistons to corresponding opposite pistons (designated on FIG. 10 by wide arrows) directly via slotted links, leaving aside kinematic pairs of slotted link, slider and a crankshaft.

The harmonic mechanism will have special advantages for diesel engines at which pressure in cylinders during a compression stroke is 2-3 times more than similar pressure in petrol engines. Therefore for harmonic diesel engines there appears an important factor: direct transfer of efforts from the expansion stroke piston to the opposite piston which makes either compression or exhaust stroke. Contrary to traditional engines this force is transfered directly via slotted rod, not via crankshaft. Contrary to traditional engines piston rods, the harmonic slotted link makes simple reciprocation, and the piston is not exposed to any skew efforts. Therefore in the harmonic diesel engine the impermeability of piston-cylinder connection becomes much better. This circumstance and also less deterioration of piston-cylinder surface play important role for increasing of diesel engines life cycle. The harmonic mechanism allows to make it in the best way. This fact, and also opportunity of improvement of lubrication system, described below, essentially increases a resource of the harmonic diesel engine.

2.4. Crankshaft

As shown in FIG. 10, in the harmonic engine the force from one piston on another, located on the same slotted link, is transferred directly via slotted link, not via crankshaft. It reduces friction losses and peak torsion efforts on a crankshaft, allowing to reduce diameters of crankshaft journals comparing with traditional engines of the same capacity. For example, in traditional four-stroke engine during an expansion stroke in one cylinder the effort from its piston is transferred via crankshaft to other pistons, including the cylinder where the compression stroke is made. Such transfer of efforts through movable connections of piston, pin, piston rod and a crankshaft results to friction losses and additional mass and durability of a crankshaft. In the harmonic coaxial engine the number of such cross torsion forces via crankshaft is twice less.. Therefore some dimensions of crankshaft of the harmonic engine can be reduced.

The FIG. 9 shows schematic images of crankshafts for three different kinds of four-cylinder engines: in-line (top), V-like or traditional opposite (middle), harmonic (bottom). Taking into account, that each crankshaft journal of the harmonic engine serves two coaxial pistons, such engine has shorter crankshaft, than a shaft of traditional V-like or opposite engine. The crankshaft of the harmonic engine (FIG. 9, below) is almost twice shorter and also has twice less bends, than a crankshaft of in-line engine with the same number of cylinders (FIG. 9, top). Every crankshaft journal of the harmonic engine works twice more effectively, than one in traditional engines, because it perceives pistons forces from two sides.

The crankshaft of the harmonic engine requires much less mass of counterbalances which serve for compensation of piston rods inertia forces in traditional engines. The less dimension, less number of bends and less counterbalance mass allow to reduce a mass of harmonic crankshaft in 3-4 times comparing to crankshaft of in-line engine or in 1.5-1.8 times comparing to a crankshaft of V-like engine with the same volume of cylinders.

2.5. System of Lubrication

The system of lubrication of interfaces of a crankshaft, slider and slotted link in the harmonic engine can be made similarly to lubrication system of traditional engines which use oil feeding through crankshaft channels. The less dimension of harmonic crankshaft and less number of its bends allow to simplify accordingly the crankshaft lubrication channel, to increase reliability of oil feeding to connections surfaces and to reduce risk of the engine overheating.

A slider in harmonic engine plays a same role as a bushing between crankshaft and piston-rod in traditional engines. However, the harmonic engine slider perceives peak forces of expansion strokes from two pistons. Besides, the slider rubs simultaneously by its outer and inner surfaces. Such conditions require much durability and wear resistance for slider material and edges of a slotted link, and also require better mode of their lubrication and cooling.

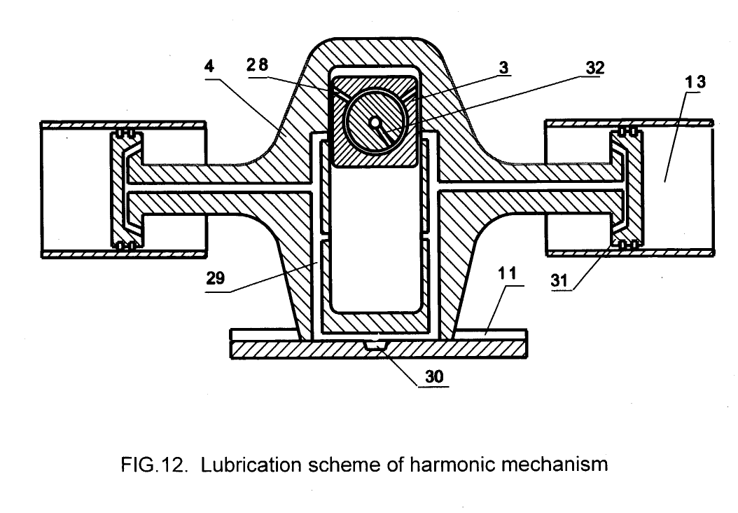

A FIG. 12 shows a possible scheme of lubricating oil contour of the harmonic piston mechanism. The inner surface of the slider 3 can be lubricated through the channel 32 drilled in a crankshaft. Through apertures 28 in slider allow to submit oil from the central aperture to outer slider edges and interface between slider and slotted link. Submission of oil to this connection can be carried out also through the channel 30 in fixed guide 11 and a slotted link 4 from below through channels in a slotted link. The oil also can move through channels 31 for cooling the head of the piston and lubrication of walls of the cylinder.

Submission of oil through a slotted link is one more benefit of harmonic mechanism, because this is an alternative lubrication channel. This channel may remain functioning in case of malfunction of the channel of lubrication through a crankshaft ensuring protection of slider against overheating. Such variant of oil feeding is impossible for traditional engine, as its piston rods make complex spatial motion and oil feeding can be done only via crankshaft channel. The additional lubricating channel through guide and slotted link reduces required flow of oil through a crankshaft and protects the engine from fast dangerous overheating in case of contamination of lubrication channel in a crankshaft. The integral design of a slotted link and the piston allows to create simple lubrication channels in a slotted link for pistons cooling.

2.6. Advantages in Dimensions and Mass

Lighter mass of elements of harmonic piston group, cylinder block, smaller number of details and connections allow to reduce essentially material consumption (aluminum allow for cylinder blocks and pistons, forged steel for crankshaft and piston rods) and cost of the harmonic engine comparing with traditional engines of same capacity. Harmonic mechanism allows to reduce considerably dimensions and number of details and to simplify manufacturing techniques of elements of crankshaft and piston group. The harmonic engine offered by this invention differs from traditional piston engines by smaller dimension and weight of case details and whole engine.

3. Other Variants of Cylinders Arrangement

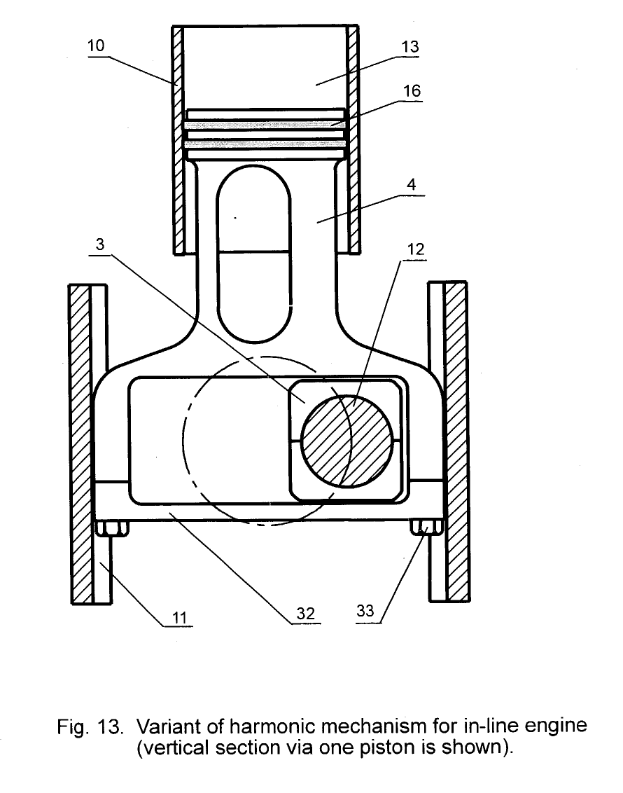

For the harmonic engine there are possible some other variants of cylinders arrangement. The FIG. 13 illustrates a variant of a slotted link for in-line engine with a vertical cylinders (Claim 3). Here a slotted link with asymmetric longitudinal window is represented. Such window allows to reduce a mass of a slotted link and to increase its width in order to ensure better distribution of forces onto slot edges. The FIG. 13 represents axial arrangement of the cylinder when the cylinder axis crosses a crankshaft axis. However harmonic mechanism allows to create disaxial variant where the cylinder is displaced more to the right from crankshaft axis (it is supposed, that the crankshaft rotates clockwise in a plane of figure). For disaxial design the form of a slotted link will better correspond to pistons pressure forces during their expansion strokes. As well as for traditional engines, in-line harmonic engine may have any number of cylinders. In-line harmonic mechanism can be used for motorcycle two-stroke engine with crankcase blowing. The structure of in-line harmonic engine allows to reduce essentially engine height (the advamtage in height corresponds to a difference between piston sizes D3 and D4 on FIG. 8). The engine vertical dimension is extremely important for cars, because the height of hood and driver's field of vision depends on it.

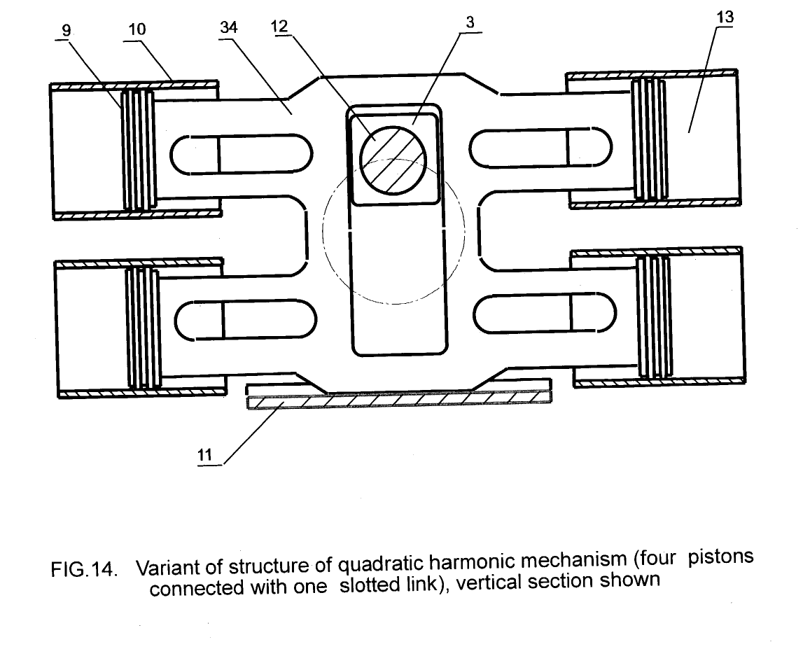

The FIG. 14 shows an idea of quadratic harmonic engine in which one slotted link 34 is connected with four pistons 9. For simplicity the figure shows an integral slotted link, but real quadratic slotted link should consist of two halves. This variant for the four-cycle engine ensures a most effective transfer of pistons efforts to each other directly through a slotted link. Each stroke of a slotted link corresponds to expansion stroke in one of four cylinders. During one cycle of the engine (two revolutions of a crankshaft) four strokes in each of four cylinders consistently alternate. Such engine can have four cylinders (one slotted link), however in this case the horizontal forces of inertia created by slotted link, are not compensated by other similar slotted link. Therefore the 4-cylinder quadratic engine has a significant unbalanced mass causing horizontal vibration. It can be partly compensated by crankshaft counterbalances. In order to increase a number of expansion strokes per one cycle of the engine and to reduce its vibration there are possible variants of 12-cylinders (three slotted links) or 20-cylinders engines (five slotted links) in which journal slotted links of a crankshaft are turned from each other accordingly on 120° or 72°. Variants of any odd number of quadratic slotted links are reasonable as well.

Variants of 8-cylinders or 16-cylinders quadratic harmonic engines hardly make sense, as in this case cylinders of different slotted links act simultaneously. Therefore the increase of cylinders number will not make crankshaft rotation smoother. So the 8-cylinders quadratic engine will have the same number of jerks per one revolution, as it is in 4-cylinder engine (FIG. 5). Similarly, variants of the quadratic engine with any even number of slotted links are not reasonable.

4. Quadratic Harmonic Engine with Cylinders Switching Off

Creation of quadratic engines with even number of slotted links (for example, 8-cylinder quadratic engine) makes sense in case when the engine is equipped by system of tripping of fuel and ignition for separate cylinders. This type of engine have variable working volume, because it has variable number of working cylinders. Such automobile engine can save fuel and allow less atmosphere exhaust, especially at city driving or driving on hilly terrain. In such engine the second quadratic slotted link constantly moves in antiphase relative to the first slotted link and counterbalances its inertia forces. Work of various cylinders can be controlled by computer connected with ignition and injection system. The computer completely blocks submission of fuel and ignition into idle cylinders. Motion of a slotted link in which all cylinders are switched off, will not create additional loading on a crankshaft as efforts from formation of vacuum or superfluous pressure in opposite cylinders will counterbalance each other. However such slotted link with the switched—off cylinders will counterbalance inertia forces made by another slotted link with working cylinders, i.e. it will compensate horizontal vibration.

5. Dynamic Loading, Speed of Rotation, Interaction with Clutch and Gearbox

In traditional piston engines a connection of the piston to a piston rod is a critical point. Its durability significantly limits the maximal rotation speed of the engine. The feature of traditional engine is that at uniform rotation of a crankshaft the piston momentary acceleration in the top dead point is peak, it exceeds momentary acceleration of the piston in the bottom dead point on 80-120% (this factor depends on the proportion of cylinder diameter, piston stroke and piston rod length).

In the harmonic engine values of piston acceleration in the top and bottom dead points are identical, and this value is approximately 25% lower than peak values of acceleration in traditional engine with similar other conditions. At uniform speed of crankshaft rotation the harmonic slotted link makes sinusoidal (harmonic) reciprocation which corresponds to optimum dynamics of loading. It reduces jerks and torsion oscillations of a crankshaft. More uniform crankshaft rotation allows to reduce masses of flywheel and torque vibration damper on a clutch disk.

The less mass of the piston combined with less peak accelerations allows to increase high-speed strength limit and the maximal rotation speed of the harmonic engine comparing with traditional engines. On the other hand, improvement of impermeability of piston-cylinder connection allows to lower a limit of minimal and idle revolutions of the harmonic engine. Therefore the offered harmonic engine will have enhanced range of working speeds in comparison with traditional engines. In many cases this quality allows to lower number of gears in automobile gearbox (especially for trucks), to simplify and reduce gearbox weight.

6. Advantages of Fuel Combustion Process, Speed and Fuel Consumption

It is known, that the traditional engine has a “jerk” motion of the crankshaft. Let us consider one stroke of piston motion of traditional engine from the top dead point to bottom one, i.e. during the period of crankshaft turning from 0° up to 180° (see. FIG. 8 below). The structure of traditional slider-crank mechanism results to that during a first quarter of a revolution (i.e. turn of a crankshaft from 0° to 90°) the piston moves approximately on 60% of whole length of the piston stroke. And during the second quarter of a crankshaft revolution (from 90° up to 180°) the piston passes only 40% of its stroke length. It means, that during the first quarter of a revolution the piston is quickly falling down into the cylinder, reaching the maximal speed of motion approximately at a crankshaft angle about 70°. Then the piston is slowing its speed down. Near the end of expansion stroke the piston stops its motion. During last ⅛ of a crankshaft revolution (from 135° up to 180°) the piston passes only 10% of stroke length. Such “jerk” dynamics of the piston results to that the first quarter of a crankshaft revolution (turning from 0° up to 90°) plays very important role for combustion of gas-fuel mixture. For effective work of the traditional engine it is important to ensure fast and full combustion of fuel during very short time interval. For this purpose there are used such measures as advancing of ignition, multi-valves mechanism, complex systems of injection and multi-point ignition. Short time of effective work of the piston (corresponding to time of the first quarter of a revolution of a crankshaft) seriously limits the maximal speed of rotation of the engine and its efficiency on high rotation speed. While the speed of front of burning in a working mix has the certain physical limit, then at high revolutions time of combustion of fuel can exceed the time of the first quarter of a revolution of a crankshaft. And then the increase in submission of a gas mixture does not cause corresponding increase of the engine speed.

The advantage of harmonic engine is, that motion of the piston during an expansion stroke has smooth sinusoidal or harmonic character. For the first quarter of a revolution of a crankshaft (turning from 0° up to 90°) the piston of passes exactly 50% of stroke length and reaches the maximal speed at a corner of a crankshaft 90° (this position is shown on FIG. 4). The second quarter of a revolution of a crankshaft also corresponds (meets) 50% of length of a working course of the piston. And even during last ⅛ revolutions of a crankshaft (from 135° up to 180°) the piston passes about 15% of the stroke length, which is 1.5 times more, than for traditional engine. Such smoother kinematics of the harmonic engine has great value for conditions of air-fuel mixture combustion since time of effective pressure in the chamber of combustion can be increased approximately by 3-5% at the same rotation speed. It gives obvious opportunities for further improving of engine efficiency: reduction of an angle of ignition and injection advance, more full combustion of fuel, increase of maximum rotation speed of the engine.

7. Advantages in Dimensions and Mass

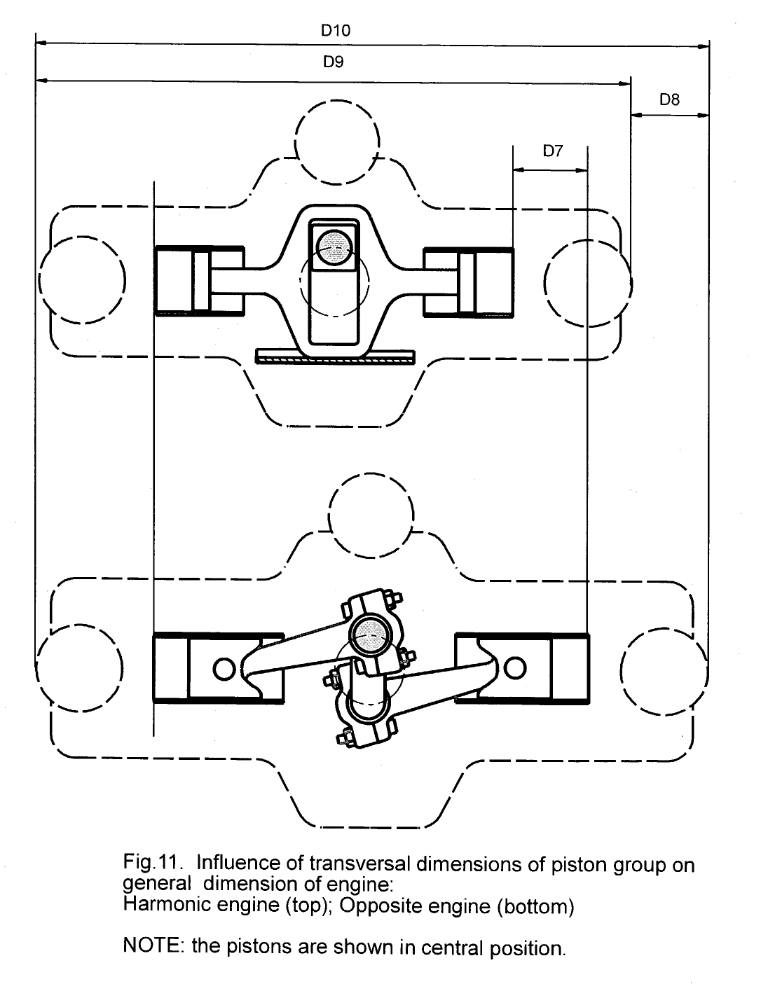

As it was mentioned above, the harmonic engine can have considerably smaller transverse dimension, than traditional opposite engine of same capacity (see FIG. 8 and FIG. 11). As a whole, the width of the coaxial harmonic engine is less approximately on 12-13%, than width traditional opposite engine (compare proportion of D9 and D10 on FIG. 8). The harmonic engine has shorter cylinders and the shorter height of cylinder block, less volume of a liquid in cooling system. Additional mass reduction can be achieved due to less thickness of walls and mass of the cylinder block, sleeves of cylinders. Reduction of thickness of cylinder block walls is reasonable because the cylinder of harmonic engine perceives considerably smaller lateral loadings and friction forces. Less transversal dimension of the engine allows to lower dimensions and mass of case details and many internal and external mechanical and electric connections (for example, transmission between crankshaft and camshafts).

The advantage in longitudinal dimension of the harmonic coaxial engine is also obvious. Due to arrangement of two pistons on one slotted link, the harmonic engine is on 20-25% shorter, than equal capacity traditional engines with opposite or V-like arrangement of cylinders, and about 40-45% shorter, than in-line engines (general length of mentioned engines correspond to length of crankshafts shown on FIG. 9). Besides the harmonic engine has more simple form of a crankshaft with less number of bends, lighter counterbalances and less number of lubrication channels inside a crankshaft.

Due to the mentioned dimensional advantages the harmonic coaxial engine can have weight on 25-30% less, than similar engines with opposite or a V-like arrangement of cylinders.

Essential reduction of dimensions and weights in such automobile units like engine and transmission, has multiplying effect. It allows to reduce accordingly the mass of carrying structures of automobile body or frame. Released reserves of mass and space can be used also for increase in useful cargo capacity, improvement of systems of safety and comfort of the driver and passengers.

8. Reducing of Exhaust Gases Emission, Lower Noise Level

The main advantage of the harmonic engine is an improved impermeability of cylinder—piston interface. The impossibility of skews of the piston and piston rings in the harmonic engine differs it from traditional engines and considerably reduces exhaust gases leakage into the engine crankcase space. Low lateral efforts of the piston reduce friction losses, increases life cycle of the engine and the periods between maintenance service operations. Lower vibration and mechanical noise of the engine improves operating conditions of seals, gaskets, valve connections of gas distributing system, injectors and all units hinged on engine. These features lower inefficient losses of a gas mixture at work of the engine and its emissions into an atmosphere, and also losses of motor oil.

Shorter cylinders and pistons height (for the same capacity of the engine), decrease friction losses for pistons, lower inefficient losses of heat in cylinders, by cooling system. Due to more compact cylinder block and better impermeability of pistons the harmonic engine gets warm faster after its start. The harmonic mechanism provides the improved mode of combustion of fuel. These factors reduce harmful emissions in an atmosphere and essentially reduce the fuel consumption during operation of automobiles or other transport means.

9. Author's Recommendations for Designing, Manufacturing of Prototype, Production and Repair of Harmonic Engines

The four-cylinder four-stroke engine with a horizontal coaxial arrangement of cylinders (FIG. 4 and FIG. 5) seems most suitable variant for design and manufacturing of an experimental prototype of the harmonic engine. However, the interested manufacturers can test manufacturing of prototypes for in-line or V-like (FIG. 13) and quadratic (FIG. 14) harmonic engines.

Due to significant differences between harmonic and traditional engines, detailed design and manufacturing of the experimental harmonic prototype require careful development of some new elements and all case details of the engine. It relates with a fact that harmonic engine has a new opposite coaxial arrangement of cylinders, new form of crankshaft and pistons and new connection mechanism between pistons and crankshaft.

The slotted link and crankshaft designing might be started from a choice of engine capacity, working volume, number of cylinders, their diameter and piston stroke length. After that it is necessary to develop drawings and to make trial samples of a crankshaft, sliders, slotted links with pistons, sleeves of cylinders. These details represent new elements of the harmonic engine, therefore it is necessary to provide some tests of their functional interaction at the special balancing stand in a dynamic mode of idle motion. There is no need to use engine case details for such stand on this stage, it is enough to have simple protective casing for safety. Development of details can be executed much quicker and more qualitatively if developers use systems of computer designing and modelling of dynamic characteristics. The testing stand should have a crankshaft drive, gauges of vibration, fixed supports for a crankshaft and guides for pistons and slotted link. The guides for slotted links and bushings of crankshaft should be motionlessly fixed on the stand and supplied with feeding of lubricating liquid. The drive of the stand should provide rotation speed of a crankshaft and the modes of acceleration corresponding to modes of the traditional engine or, probably, on 15-20% more. The result of tests of new details of the harmonic engine at the stand should become well balanced new elements of the harmonic engine which have minimal dimension and weight with necessary margin of safety for all modes.

After manufacturing of mentioned new elements of the harmonic engine it is necessary to design its cylinders and corresponding case details, camshafts and systems of cooling with all small elements. It is necessary to take into account a heavy thermal operating mode of slider and to provide more powerful oil pump, oil radiator and the feeding flow of motor oil increased in 2-3 time on a crankshaft and slotted links accordingly to FIG. 12 or another scheme. For prototypes of harmonic engines with liquid cooling the radiator and cooling pump should have approximately same dimensions and power as they are for traditional engines of same capacity. It is probable, that for the serial harmonic engines will have smaller radiator, because harmonic engine will have less thermal losses of friction because of less lateral loading on walls of cylinders. Air turbulence in crankcase space of the engine, caused by motion of slotted links and pistons, will be less than for traditional engines, because harmonic engine has more simple motion of parts.

The crankshaft and camshafts should be made so that the operating procedure of cylinders met a table described in this specification (FIG. 10). Camshafts will have shorter length of a shaft, another angle positioning of cams. The length of valves stroke, their sizes and height of cams of a camshaft may have the same dimensions, as in traditional engine of similar capacity. The number of valves on one cylinder might be chosen under the discretion of the manufacturer. However it is necessary to take into account, that the harmonic engine has better conditions of fuel combustion, described above, and consequently for an experimental prototype the elementary system consisting of two valves is enough. Small details (valves, injectors, spark plugs, fuel pump, etc.), and also hinged units of the engine (starter, generator, ignition distributor, cooling pump, fan etc.) do not need special designing and might be taken from equipment number of serial production.

For an experimental prototype of the engine it is possible to use submission of a gas mixture from the usual carburettor or laboratory injecting system with adjustable doze of fuel injection. A silencer does not require special development as the exhaust mode of the harmonic engine is a little softer than one of traditional engine, because its pistons are moving more smoothly near the top dead point.

After assembly of the experimental prototype it is necessary to carry out research tests and adjustment of the engine on the laboratory test bed equipped with necessary gauges and a brake of the engine (hydraulic or electric inverter). Due to results of laboratory tests of the prototype it is possible to make constructive changes and to make a trial series of engines for trial runs on automobiles. Installation of the harmonic engine in existing models of automobiles will not cause difficulties as the harmonic engine has smaller sizes and weight, and also creates smaller vibration, than the traditional engine of similar capacity.

After trial runs and additional engineering changes the harmonic engine should be certified and ensured with necessary sanctions. At initial organization of a serial production of automobiles with the harmonic engines it is enough to use existing models of automobiles. However in the future it is reasonable to use opportunities of an automobile design improvement according to less dimension and mass of the harmonic engine and transmission.

In process of operation of the harmonic engine there occurs a deterioration on flat surfaces of interface of slider with a slotted link, and also in connection of slider with crankshaft (transformation of slider's cylindrical aperture into oval one, elongated in an axis of the cylinder). The slider will be probably main element of replacement during repair of harmonic engine. During major repair of the engine it is required to replace original slider by repair size slider which should have an aperture of smaller diameter and the increased thickness of lateral walls. Such slider will allow to remove a gap between a slotted link and crankshaft and to restore normal work of the engine. It is expected, that replacement of piston rings at repair of the harmonic engine will be used less often, than slider replacement. Therefore during design of the serial engine it is possible to make simple replacement of slider without removal of blocks of cylinders and polishing of a crankshaft. For the engine shown on FIG. 4 and FIG. 5 it might be done from the side of top cover of the engine or from the crankcase bottom side.

I claim:

1. A connection of a crankshaft with pistons in internal combustion engines by means of known harmonic sliding slotted link mechanism, which consists of:
A crankshaft which makes rotary motion around its geometric axis;
A slotted link which is connected motionlessly with one or more pistons and reciprocates along a cylinder axis perpendicularly to axis of a crankshaft and having a slot, perpendicular to axes of the cylinder and crankshaft, used for slider traveling in it;
A slider which is put on a crankshaft journal, moves lengthwise the slot of the specified slotted link, transfering forces directed along an axis of the cylinder, from a slotted link to the crankshaft or vise versa;
Optional guides which set a direction of a slotted link motion.

2. A configuration of the harmonic piston engine with opposite paired arrangement of cylinders in which each slotted link is fixed to two pistons of the cylinders placed either coaxial or disaxial (displaced in a vertical plane relative to crankshaft axis).

3. A configuration of the harmonic mechanism for in-line and V-like piston engine where each piston corresponds to one slotted link.

4. A configuration of the harmonic piston engine with a quadratic arrangement of cylinders in which each slotted link is motionlessly connected to four pistons.

5. Lubrication system of elements of the harmonic mechanism through motionless guide and a slotted link.
